(19) United States
(12) Patent Application Publication
(10) Pub. No.: US 2018/0348453 A1
(43) Pub. Date: Dec. 6, 2018

(54) OPTICAL MODULE AND OPTICAL ENGINE COMPRISING SAME

(71) Applicant: OPTELLA INC., Gwangju (KR)

(72) Inventors: Eun Gu LEE, Sejong (KR); Sang Soo LEE, Daejeon (KR); Jyung Chan LEE, Daejeon (KR)

(21) Appl. No.: 15/778,832

(22) PCT Filed: Jun. 21, 2016
(86) PCT No.: PCT/KR2016/006562

§ 371 Date: May 24, 2018

(30) Foreign Application Priority Data
Nov. 25, 2015 (KR) 10-2015-0165544

(51) Int. Cl. G02B 6/42; G02B 6/12; G02B 6/122

(52) U.S. Cl. CPC G02B 6/424; G02B 6/4214; G02B 6/4251; G02B 6/122; G02B 6/12007; G02B 6/4249; G02B 6/428

(57) ABSTRACT

An optical module includes: a mount; an optical element provided at the mount and having a light source and/or a light-receiving element; an optical element driving driver (optical element-related circuit device) including a driver, which is provided at the mount and drives each optical element, or at least one among processing devices for processing signals generated by the light; a stem including a spacer provided at a predetermined height to secure a space for an optical interface above the optical element around the optical element at the mount, and forms an electrical interface with a circuit board (substrate); and a light guide plate forming the optical interface with the stem on one side, receiving the light from a light source at one surface and emitting the light to the other surface, or receiving the light at the other surface and emitting the light to one surface.

### TECHNICAL FIELD

The present invention relates to an optical communication device, and more specifically, to an optical module or an Optic Sub Assembly (OSA) for an optical engine, which can simply and efficiently couple an optical device and an optical waveguide that can be used in optical communications, and an optical engine including the same.

### BACKGROUND ART

In accordance with the expansion of services based on large contents, abrupt increase in distribution of smart phones and abrupt increase of data centers, methods of increasing data traffic capacity are continuously studied. To solve this problem, the International Organization of Standardization related to communications announces standards about using single-wavelength multi-channel techniques and wavelength division multiplexing techniques, and many institutions and researchers study methods of implementing these techniques. These standards and techniques should solve the issues of low cost, high speed, small size and low power, and optical transmitters based on a laser array are developed and used in real application fields as a method for overcoming the issues from the aspect of an optical transceiver, which is a component constituting a network.

Generally, a lens is used to enhance the efficiency of optical coupling between a laser and an optical waveguide in an optical transmitter. If optical coupling is implemented using a lens, efficiency of optical coupling is enhanced or tolerance thereof is increased according to the characteristic of the system, or an optimized package structure can be designed at a proper level between the two. However, if the distance between lasers is designed to be 250 um for optical coupling with an existing optic fiber array and an optical waveguide array, the lens used for optical coupling should be configured in the form of an array, and there is a disadvantage of increasing the cost according thereto. If the laser installation pitch is increased to reduce the cost of manufacturing the lens array, the number of lasers that can be manufactured from one wafer is reduced, and this leads to increase of cost of the lasers.

Existing optical engines use two lenses or one lens since the distance between a light source (or photodetector) and an optical waveguide (or optic fiber) is long as the optical engines basically use a 45-degree mirror. In this case, since many devices such as guide posts, latches and the like are inserted for optical coupling, the structure is complicated, and the packaging process is difficult. In addition, since most of the existing optical engines use an optical waveguide array that does not use an optical multiplexer (optical de-multiplexer), they are inappropriate to be used in a system which uses multiple wavelengths.

If a plurality of lasers is formed in one chip, this is difficult to be used in the specifications of 40G BASE-LR4 or 100G BASE-LR4 using four wavelengths of wide wavelength spacing. It is difficult to generate different wavelengths if a plurality of lasers is formed in one chip, and the reasons are as follows. First, although a wide gain curve should be obtained since a plurality of lasers uses the same active layer, this condition is difficult to satisfy during the growth. Second, although the oscillation wavelength of a laser varies according to the length of a resonator, it is difficult to change the length of the resonator if a plurality of lasers is formed in one chip. Although a laser may be manufactured to operate in a comparatively wide range on one chip, it is difficult to endure currently increasing traffic since there is a disadvantage of eventually increasing the manufacturing cost.

To output wavelengths different from each other, a method of implementing a laser array by installing independent single lasers on one mount may be used. In this case, since the space between the lasers can be increased without reducing the number of lasers per wafer and the space of the lens arrays can be extended, a lens array of a low price with a comparatively long distance between the lenses can be used. However, although a lens array of a low price is used, if an existing packaging method is used, there are still disadvantages from the aspect of parts used in a package, time required for packaging and cost of packaging.

For example, an optical transmitter operating at a high speed uses a package of mini DIL which uses ceramic-feedthrough to guarantee a high-speed electrical interface and high reliability, and since the cost of a case used as a part is high and works are carried out in a narrow space inside the case, there is a disadvantage in that the price of the optic sub assembly (OSA) itself increases as the packaging time is extended.

The fundamental reason of generating these problems is that it is caused by a contradictory situation in which although an optical transceiver which connects the physical layer is required to have high performance from the aspect of operation due to the rapidly increasing data traffic, the size of components constituting a network should be reduced from the aspect of management, and the price should be lowered due to the problem of cost of facility.

An optical module of high performance, low price, low power and small size is needed to solve the problems and contradiction of the existing technical situation.

### DISCLOSURE OF INVENTION

### Technical Problem

Therefore, the present invention has been made in view of the above problems, and it is an object of the present invention to provide an optical module of a package type of a simple structure, which can solve the problem of using a laser array operating at a single wavelength for the sake of compatibility with an existing optical waveguide array and solve the problem of using a lens array by assembling lasers operating at different single wavelengths in the form of an array to use multiple wavelengths.

In addition, another object of the present invention is to provide an optical module having a configuration easy to solve the disadvantage of working in a narrow space of five closed sides and the difficulty of using a package case in an optical transceiver of high performance and low price since the package case is expensive.

### Technical Solution

To accomplish the above objects, according to one aspect of the present invention, there is provided an optical module comprising: a stem including: a mount; an optical element installed on the mount and provided with at least one of a light source and a light-receiving element; an optical element driving driver (optical element-related circuit device) configured to be provided with a driver installed on the mount to drive each of the optical elements or at least one of processing devices for processing a signal generated by the light received by the optical element; and a spacer installed around the optical element in the mount at a predetermined height to secure a space protruded above the optical element for an optical interface, wherein an electrical interface with a circuit board (substrate) is formed; and a light guide plate block having a light guide plate which forms an optical interface with the stem on one side to receive light of the light source through one surface and output the light through the other surface or receive light from the other surface and output the light to the one surface.

In the optical module of the present invention, the light source is a laser diode (LD), and the light-receiving element is a photodetector (PD). The driver for driving each of the optical elements may include a laser diode driving driver, and the processing device may include a trans-impedance amplifier (TIA).

In the optical module of the present invention, the light guide plate block may further have an optical multiplexing device for receiving light from the other surface of the light guide plate and multiplexing wavelengths, and at this point, the optical multiplexing device may include at least one element among an Arrayed Waveguide Grating (AWG) and a Thin Film Filter (TFF).

In the optical module of the present invention, the optical element and the optical element driving driver may be installed on a surface of a flexible printed circuit board (FPCB), and the spacer may also be attached on the surface of the FPCB.

In the optical module of the present invention, a supportive body is placed on at least one of the surface or the other surface of the light guide plate in the light guide plate block, and a surface of the light guide plate block configuring the optical interface with the stem at least partially matches the spacer in size and shape to face the optical element and the one surface of the light guide plate each other in correct position. That is, in the present invention, the spacer may be formed along the edge of at least part of the interface surface of the light guide plate block to easily match the light guide plate block in correct position for the sake of light efficiency.

In the present invention, light of the light source may be inputted from a side surface of the light guide plate, and the inputted light may be outputted to the opposite side surface. Contrarily, light may be inputted from the opposite side surface, and the light may be outputted to the light-receiving element through the one side surface.

In the present invention, generally, a plurality of laser diodes may be provide in the stem, and light emitted from the plurality of laser diodes may be inputted into the light guide plate together.

In the light guide plate of the present invention, a mirror surface is formed on the light guide plate in the light guide plate block to reflect light inputted into or outputted from the optical element from the mirror surface at a predetermined angle, e.g., an angle of 45 degrees, and the optical module has a section in which the light progresses along the light guide plate before the reflection (when the light guide plate is coupled to the light-receiving element) or after the reflection (when the light guide plate is coupled to the light source).

An optical engine of the present invention for accomplishing the objects is provided with, in addition to the optical module of the present invention as described above, an optical input-output unit configuring an optical interface with the other surface of the light guide plate block to receive outputted light or input light of the outside into the light guide plate.

The optical input-output unit may be configured in the form of a block having an optic fiber and a supportive body for fixing the optic fiber, and at this point, edges of optical interface surfaces of the optical input-output unit and the light guide plate block may be formed in the same shape and size at least in part to match each other.

### Advantageous Effects

According to the present invention, there is provided an optical module and an optical engine, which can implement high performance capable of increasing traffic capacity in optical communications, have a comparatively simple and compressive configuration, and can be manufactured at low manufacturing cost.

According to the present invention, getting out of the typical packaging method used in the prior art, a light guide plate block having a light guide plate can be easily spaced from and combined with a spacer of a stem to have a small space, and through a configuration of involving the light guide plate block, increase of capacity can be implemented at comparatively low cost by easily involving an optical multiplexing device in the entire waveguide process including an optic fiber section.

### BRIEF DESCRIPTION OF THE DRAWINGS

FIG. 1 is a partially exploded perspective view showing the basic configuration of an optical engine according to an embodiment of the present invention.

FIG. 2 is a partially exploded perspective view showing the configuration of an optical engine according to another embodiment of the present invention.

FIG. 3 is a front cross-sectional view showing the cross section vertically cutting the optical engine shown in FIG. 2.

FIG. 4 is a perspective view showing an example of a stem part of an optical engine configuring the present invention.

FIG. 5 is a perspective view showing an example of a light guide plate block of an optical engine configuring the present invention.

FIG. 6 is a perspective view showing an example of an optical input-output unit of an optical engine configuring the present invention.

FIG. 7 is a conceptual exploded perspective view showing a structure modified by adding a 45-degree mirror to a light guide plate block configuring an optical engine of the present invention.

FIG. 8 is an exploded perspective view showing an optical engine using a light guide plate block removing an unnecessary body part from FIG. 7.

FIG. 9 is a front cross-sectional view showing the cross section vertically cutting the optical engine shown in FIG. 8.

FIG. 10 is an exploded perspective view showing a form of an optical input-output unit configuring an optical engine of the present invention.

FIG. 11 is an exploded perspective view showing another form of an optical input-output unit configuring an optical engine of the present invention.

FIG. 12 is an exploded perspective view showing still another form of an optical input-output unit configuring an optical engine of the present invention.

### BEST MODE FOR CARRYING OUT THE INVENTION

The present invention will be hereafter described in detail through embodiments, with reference to the accompanying drawings.

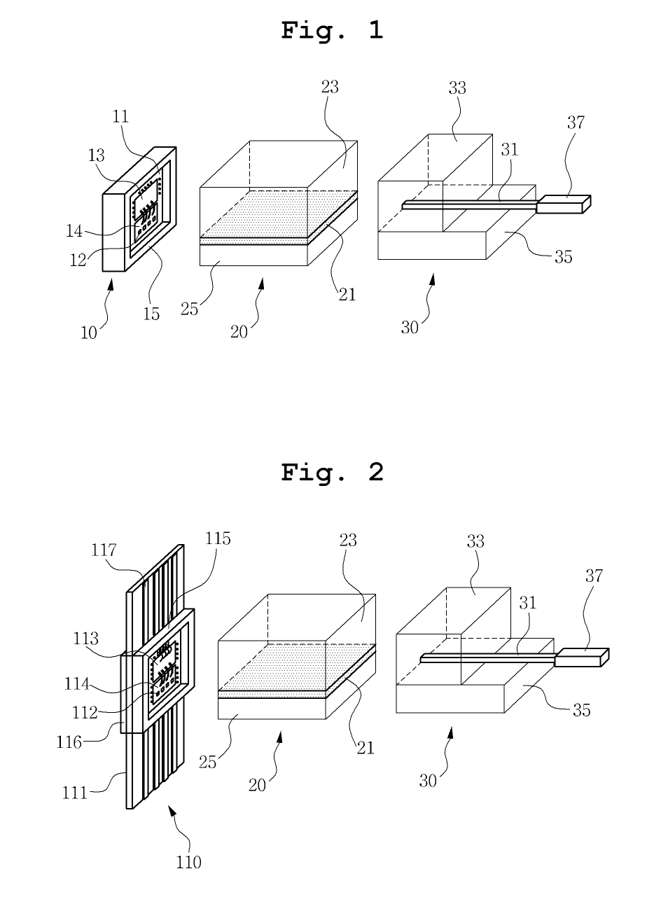

Describing with reference to FIG. 1, in this embodiment, an optical engine largely includes three parts of a stem 10, a light guide plate block 20 and an optical input-output unit (an optical coupler) 30.

Here, in the stem 10, a rectangular spacer 15 of a sidewall shape is formed along the edge of the top surface of a mount 11 configuring a rectangular plate, in one piece as if being protruded upward to form a shape of a picture frame. In the middle of the mount, a sub-mount 14 having four laser diodes LD 12 installed on the top surface thereof in a row and a diode driving driver chip 13 for adjusting the laser diodes are provided.

Pads and connection lines for electrical connection are installed in the mount 11, the laser diode driving driver chip 13 and the sub-mount 14 to flow current to the laser diodes.

The light guide plate block 20 has a light guide plate 21 of a plate shape, a side surface of which faces the laser diode row of the stem 10, and supportive bodies 23 and 25 are combined on a wide surface and the other surface of the light guide plate 21 to form a six-sided block. The rectangular shape formed by the spacer 15 and the light guide plate block have the same size and shape to match each other on a surface on which the stem 10 and the light guide plate block 20 face each other and configure an optical interface.

The optical input-output unit is prepared such that a side surface of the light guide plate 21 opposite to the side surface facing the laser diodes may face an end portion of an optic fiber installed in the optical input-output unit. A plurality of optic fibers, as many as the number of laser diodes, configuring a row or a single optic fiber is fixed between the two supportive bodies, and a V-shape groove for inserting the optic fiber is formed on at least one of the two facing supportive bodies of the optical input-output unit to fix the optic fiber. The optical input-output unit also configures an optical interface with an optical path external to the optical engine.

A laser diode of a vertical cavity surface emitting laser (VCSEL) type having a low dispersion degree along the progress is preferably used as the laser diode 12 to enhance light transmitting efficiency, and since tightly sealing a space surrounded by the spacer is preferably to extend the lifespan of the laser diode, the spacer 15 and the light guide plate block 20 are tightly attached, while matching each other, using a sealant or an adhesive of high sealing force.

The height of the spacer 15 is designed to reduce the distance of light emitted from a light emitting surface of the laser diode 12 until the light enters the side surface of the light guide plate, and the surfaces configuring the optical interfaces are formed in the same shape and size for easy matching to facilitate assembly of the stem and the light guide plate block and assembly of the light guide plate block 20 and the optical input-output unit 30 and to enhance light transmitting efficiency by the accurate matching between the laser diodes 12 and the light guide plate 21 and between the light guide plate and the optic fiber 31 of the optical input-output unit.

In addition, on the surface configuring an optical interface between the stem 10 and the light guide plate block 20 and the surface configuring an optical interface between the light guide plate block and the optical input-output unit 30, the side surface of the light guide plate and the cross section of the end portion of the optic fiber, through which light is inputted and outputted, may be formed as an angled facet forming an acute-angle slope with respect to the direction of the light.

In addition, an anti-reflection coating film may be formed on the surface configuring an optical interface to enhance light transmitting efficiency.

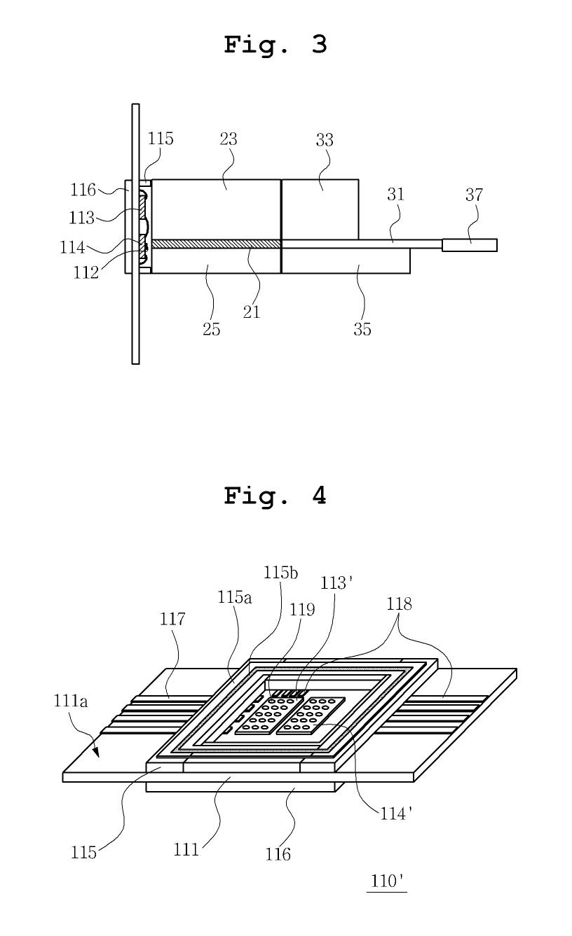

FIGS. 2 and 3 are an exploded perspective view and a front cross-sectional view of another embodiment of an optical engine of the present invention.

Comparing with the embodiment of FIG. 1, there are some differences in the configuration of the stem part.

The stem 110 has a mount 111, a spacer 115 of a rectangular sidewall shape formed in a portion of the mount along the edge of the front surface, and a bottom 116 formed on the entire rear surface thereof. The mount is configured of a flexible printed circuit board (FPCB) on which connection pads and conductive lines are formed at a plurality of positions.

A sub-mount 114 having a plurality of laser diodes 112 formed in a row and a diode driving driver chip 113 are positioned in the area surrounded by the spacer 115.

An electric pad for connection to an electric pad of an external circuit substrate is formed outside the spacer area of the flexible printed circuit board, and a configuration similar to the embodiment of FIG. 1 is disclosed in the inner area of the spacer.

FIG. 4 is a conceptual perspective view showing an example of the configuration of the stem in more detail.

The stem largely includes a spacer 115, a mount 111 and a bottom 116, and a material used for the stem may be a polymer, ceramic, metal or silicon-based material or a combination of these.

In the embodiment of FIG. 4, the spacer and the mount are formed of a combination of polymer and metal, and the bottom is formed of metal. The classification and manufacturing material of these configurations are for easy understanding of the description, and other components may be added or omitted according to the object.

For example, a system configured of only a spacer and a mount may be considered. In this case, the mount may also perform the function of the bottom. As another example, the mount may be separated from an electrical interface. This is since that although they may be manufactured as a single form according to the material for manufacturing the mount, it may be easier to use if the mount is manufactured to be separated from the electrical interface.

In FIG. 4, the spacer 115 performs a function of maintaining a constant distance between the laser diode 112 (or the photodetector) and the optical waveguide. If the function of maintaining the distance can be provided, the spacer 115 and the mount 111 may be manufactured in one piece. In addition, the spacer, the mount and the bottom 116 may also be manufactured in one piece. Here, the one piece means that they are manufactured as one part not to perform a work of bonding or the like of the components during the packaging process. Contrarily, a separated type is defined as manufacturing the components as different parts and performing a work of bonding or the like during the packaging process.

A pad for packaging 115a of the spacer is for physically coupling to the light guide plate block. A metal, ceramic, glass or silicon-based material is preferable for strong coupling and hermetic sealing.

In addition, the pad for packaging 115a may be integrated with or separated from the spacer depending on the manufacturing material of the spacer. Although the pad for packaging may form one or more trenches 115b as shown in FIG. 3 for the strength of bonding to the light guide plate block and convenience of packing process, these trenches may not be formed.

The mount 111 is a place where a laser diode or a photodetector, a laser diode driving driver, a TIA and the like are attached and performs a function of providing an electrical interface with the outside. At this point, all of the laser diode, photodetector, driving driver, TIA and other elements may be included as the elements installed on the mount, and the elements may be each or a combination of these.

For example, only laser diodes may be attached on the mount. In this case, the photodetector may be manufactured as an independent module having a shape similar to the shape of an optical sub-assembly (OSA) proposed in the present invention. In addition, in this case, the laser driver may be a component of a board on which the OSA is installed.

As another example, the laser diodes and the laser diode driving driver may be attached on the mount. FIG. 2 shows an example of attaching laser diodes and the laser diode driving driver (or photodetectors and a TIA) on the mount. Here, other elements may be passive elements, such as resistors, capacitors and inductors, or active elements.

The top pad for driver (TIA) 113′ and the top pad for LD (PD) 114′ formed on the mount may be formed in one piece or may be separately formed as shown in FIG. 2. These forms may also vary according to the material constituting the mount and the function of the mount. For example, if the mount is mainly formed of synthetic resin (e.g., PCB), separating the two top pads is preferable since heat transfer between the two top pads can be prevented.

However, if the mount is formed of metal as another example, the mount itself may function as a top pad, and in this case, separation itself may be difficult. However, even in this case, thermal noises between the top pads may be minimized by using a separation structure like a trench.

In FIG. 4, The top pad for driver and the top pad for LD may be connected to the bottom through a via 119. This is to discharge the heat generated inside the stem to the outside using the via and the bottom. If the manufacturing material of the mount is mainly synthetic resin, the via is preferable. However, if the manufacturing material is a metal, ceramic or silicon-based material, it is preferable not to use a via from the aspect of ease of manufacturing and manufacturing cost since heat conductivity of the material itself is excellent.

The mount may also perform a function of forming an electrical interface with the outside. The electrical interface may be configured of high speed signal lines for transferring signals and control lines for monitoring control and performance of the laser diode or the photodetector. At this point, the electrical interface may be configured in the form of a pattern as shown in FIG. 4, may be configured using a via 119, or may use a lead pin. Alternatively, the electrical interface may be configured as one of a via, a pattern and a lead pin or a combination of these. These configurations may also vary according to the material used for manufacturing the mount or the function of the mount.

When the electric elements are attached on the mount together, an electric circuit may be configured on the mount. For example, an electrical filter may be used to remove noises of a power signal inputted into the electric elements. Alternatively, a circuit such as an impedance matching circuit may be configured to adjust a signal level.

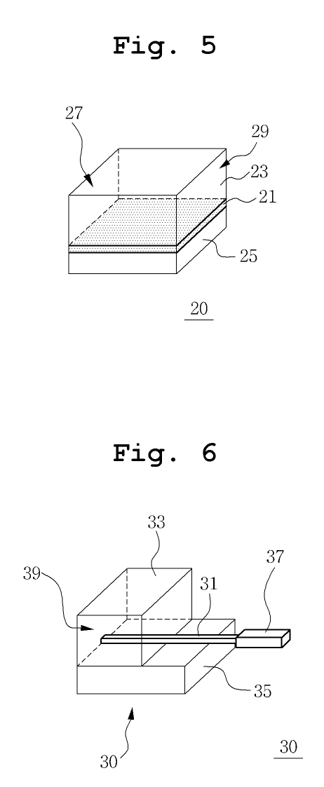

FIG. 5 is a perspective view conceptually showing a light guide plate block.

Here, the light guide plate block 20 includes a top material 23, a light guide plate 21 and a bottom material 25. The position of the light guide plate 21 is determined according to the optical element positioned in the stem, and the light guide plate block may be manufactured in a form omitting any one of the top material 23 and the bottom material 25. Although both of the top material 23 and the bottom material 25 may not be included if thickness of the light guide plate 21 itself is sufficient, since focusability of light may be lowered if the light guide plate is thick, at least one of the top material 23 and the bottom material 25 will be needed in reality.

Preferably, the size and the shape expressed by the outer line of the surface 27 of the light guide plate block 20 attached to the stem are the same as the outer size and shape of the stem. The surface 27 attached to the stem may have an anti-reflection (AR) coating film, an angled facet or both of them to guarantee performance of the optical elements by reducing reflection.

In the case of the angled facet, the stem may also have an angle of inclination corresponding thereto for attachment to the stem.

Preferably, the surface 29 attached to the optical input-output unit may have a form of an angled facet. This may have an effect of enhancing ease of manufacturing and reducing the manufacturing cost.

In FIG. 5, the light guide plate block 20, by itself or adding a device formed as a separate block (not shown), functions as an optical multiplexing device for multiplexing optical signals of different wavelengths, de-multiplexing the multiplexed optical signals or transferring multiple channels of different paths to the photodetector PD from the functional aspect, and the light guide plate block 20 may be a passive optical element (MUX/DEMUX) such as a combination of an AWG or a Thin Film Filter (TFF). If only the concept of optical multiplexing of different wavelengths is considered in particular, it may be a passive optical element operating regardless of the wavelength like a splitter or the like. In addition, the light guide plate block may be a simple optical waveguide according to the object of using the optical sub-assembly (OSA) described in the present invention. Here, the optical waveguide is a plate-type waveguide, i.e., a light guide plate.

The shape of the optical input-output unit forming an interface with the light guide plate block may vary according to whether the light guide plate block is an optical multiplexing device or a simple optical waveguide.

The corresponding surface 27 of the light guide plate block, which faces the spacer of the stem, achieves hermetic sealing along the edge to block communication of air and moisture, and in this case, it may has an effect of extending the lifespan of the optical module by preventing degradation of the laser diode.

FIG. 6 is a conceptual perspective view showing the optical input-output unit.

The optical input-output unit may be configured to include an optic fiber block and an optic fiber pigtail, and the optical interface with the outside may be configured in the form of an optical receptacle 37 or an optical patch cord. At this point, the surface attached to the light guide plate block may use an angled facet, an anti-reflection (AR) coating film or both of them to improve optical performance by reducing the effect of reflection.

Since a connection port may be configured as a single port if the light guide plate block includes a multiplexing and de-multiplexing element and a plurality of connection ports configures an array if the light guide plate block is simply a light waveguide, the optical input-output unit also has connection ports as many as the connection ports of the light guide plate block. For example, if the light guide plate block multiplexes different wavelengths of four channels and outputs the multiplexed wavelength through one port, the optical input-output unit also has one port, and if the light guide plate block outputs four channels through different ports (in this case, the wavelengths may not be different from each other), the optical input-output unit also has four ports.

FIG. 6 is merely an example provided to aid the understanding of the present invention, and actually, the optical input-output unit may have previously known various forms, for example, a fiber ferrule, a fiber ferrule including a fiber block, a form mixing a fiber block and a patch cord or a receptacle as shown in FIG. 5, and a form of receptacle, according to the object of using the optical sub-assembly (OSA) described in the present invention.

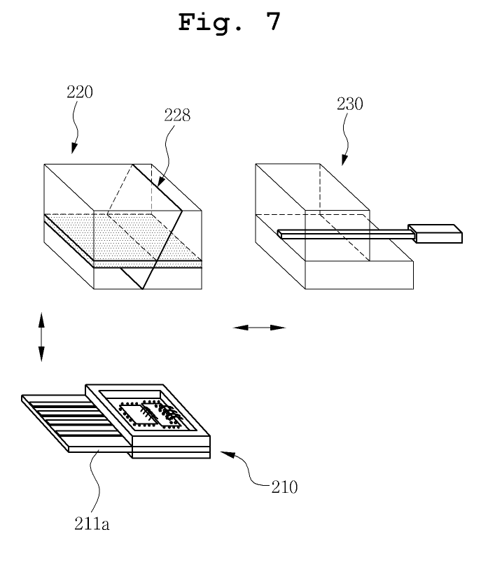

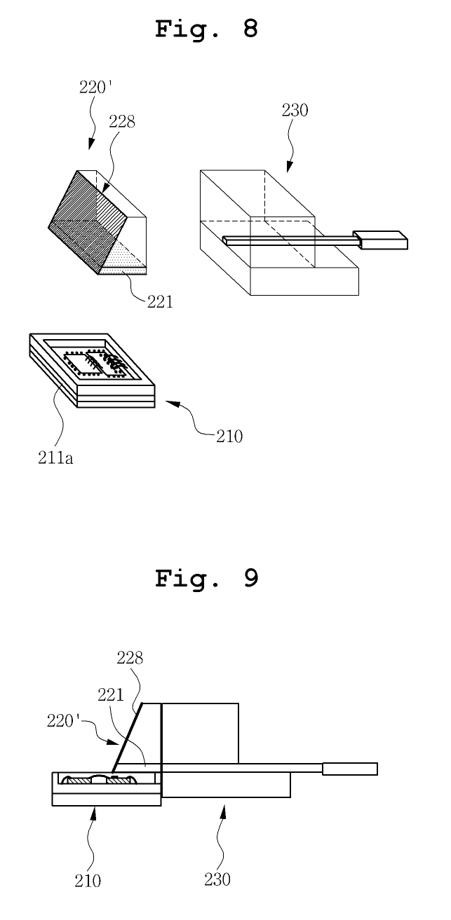

FIG. 7 shows a structure modified by adding a 45-degree mirror 228 formed to cross the light guide plate block to the light guide plate block 220. If the 45-degree mirror 228 is added, it is advantageous in that the light guide plate block 220 does not use the bottom material placed under the light guide plate 221 of FIG. 7, but the other surface of the light guide plate is directly attached to the stem 210 as shown in the exploded perspective view of FIG. 8 and the front cross-section view of FIG. 9 to enhance efficiency of optical coupling.

In the case of FIG. 7, the stem 210 tilts at an angle of ninety degrees to face the laser diodes upward unlike the embodiments described above, and the configurations and functions of the light guide plate block 220 and the optical input-output unit 230 may be the same as or similar to those of the embodiments described above.

In addition to omitting the bottom material from the light guide plate block 220 as shown in FIG. 7, the light guide plate block 220′ of FIG. 8 may be formed by omitting the portion on the left side of the mirror surface from the light guide plate block 220 with respect to the mirror 228 as shown in the figure. In this case, the 45-degree mirror may be formed by creating a high reflection layer to form a mirror on the exposed surface of the light guide plate cut by the displayed surface of the mirror 228. To make an optical engine, in the light guide plate block 220′, if the other surface of the light guide plate is attached to match a corresponding portion (the left side end) of the spacer of the stem 210 and the left side surface of the light guide plate is installed to be tightly attached to match the upper portion of the optical input-output unit 230, assembly and coupling of the stem, the light guide plate block and the optical input-output unit may still be easily accomplished.

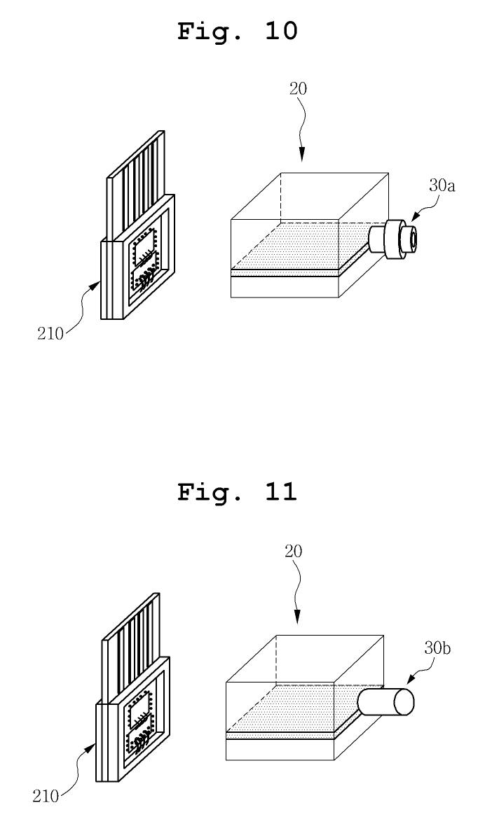

FIGS. 10 to 12 show various forms of the optical sub-assembly (OSA) described in the present invention to aid the understanding. However, the forms are not limited thereto, and since those skilled in the art may sufficiently understand on the basis of the description stated in the present invention, all the example described in the present invention will not be shown.

FIG. 10 is a view showing a case in which the optical input-output unit is a receptacle 30a, and since there is one output port, the light guide plate block 20 includes the wavelength multiplexing and de-multiplexing function when the optical input-output unit operates as multiple channels.

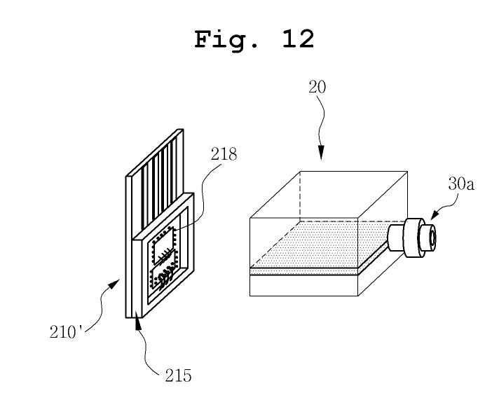

FIG. 11 shows a case in which the optical input-output unit is a ferrule 30b. In the same manner, since there is one output port, the light guide plate block 20 includes the wavelength multiplexing and de-multiplexing function when the optical input-output unit operates as multiple channels.

A case in which the optical interface of the optical input-output unit is an MPO as shown in the example described above may be considered, and in this case, a method of using a fiber block and a fiber array is preferable.

FIG. 12 shows a case in which the body of the stem 210′ is metal. In this case, a lead pin 218 is preferably used as the electrical interface between the inside of the stem 210′ and the optical sub-assembly. When the stem 210′ is metal and a lead pin 218 is used as shown in FIG. 12, it is advantageous in that hermetic sealing is easy.

While the present invention has been described in detail with respect to the stated specific embodiments, it will be apparent to those skilled in the art that various modifications and changes can be made within the scope of the present invention, and it is natural that these modifications and changes fall within the scope of the appended claims.

1. An optical module comprising:
a stem including:
a mount;
an optical element installed on the mount and provided with at least one of a light source and a light-receiving element;
an optical element driving driver (optical element-related circuit device) configured to be provided with a driver installed on the mount to drive the light source or at least one of processing devices for processing light received by the light-receiving element; and
a spacer installed around the optical element in the mount to be higher than the optical element to secure a space protruded above the optical element for an optical interface,
wherein an electrical interface with an external circuit is formed; and
a light guide plate block having a light guide plate which forms an optical interface with the stem on one side to receive light of the light source through one surface and output the light through the other surface or receive light from the other surface and output the light to the optical element through the one surface.

2. The module according to claim 1, wherein the light source is a laser diode LD, the light-receiving element is a photodetector PD, and the driver for driving each of the optical elements includes a laser diode driving driver or a TIA.

3. The module according to claim 1, wherein the light guide plate block further has an optical multiplexing device for receiving light from the other surface of the light guide plate and multiplexing wavelengths, and the optical multiplexing device includes at least one element among an Arrayed Waveguide Grating (AWG) and a Thin Film Filter (TFF).

4. The module according to claim 1, wherein in the stem, the optical element and the optical element driving driver are installed on a surface of a flexible printed circuit board (FPCB) which configures the mount, and the spacer is also attached on the surface of the FPCB.

5. The module according to claim 1, wherein a supportive body is coupled to at least one of the surface or the other surface of the light guide plate in the light guide plate block, and a surface of the light guide plate block configuring the optical interface with the stem has a size and a shape at least partially matching the spacer to place the optical element and the one surface of the light guide plate in correct position of facing each other.

6. The module according to claim 5, wherein in the light guide plate block, the supportive body is positioned on the surface or the other surface of the light guide plate, and the surface of the light guide plate block configuring the optical interface with the stem matches the spacer overall along an edge so that the optical element and the one surface of the light guide plate face each other in correct position, and the spacer and the light guide plate block achieve hermetic sealing along the edge to block communication of air and moisture.

7. The module according to claim 1, wherein a mirror surface is formed on the light guide plate of the light guide plate block to reflect light inputted into the optical element or outputted from the optical element from the mirror surface at a predetermined angle, and the optical module has a section in which the light progresses along the light guide plate before the reflection (when the light guide plate is coupled to the light-receiving element) or after the reflection (when the light guide plate is coupled to the light source).

8. An optical engine configured by further providing, in the optical module according to claim 1, an optical input-output unit configuring an optical interface with the other surface of the light guide plate block to receive light outputted from the light guide plate or transfer the light to an outside, or receive light of an external light source and input the light into the light guide plate.

9. The module according to claim 8, wherein the optical input-output unit is formed in a form of an optical input-output block having an optic fiber and a supportive body for fixing the optic fiber, and edges of optical interface surfaces of the optical input-output block and the light guide plate block are formed in the same shape and size in part to match each other so that the other surface of the light guide plate may face an end surface of the optic fiber in correct position.
